(19) United States
(12) Patent Application Publication
(10) Pub. No.: US 2006/0108159 A1
(43) Pub. Date: May 25, 2006

(54) Motorcycle with support wheel system

(75) Inventors: Lars Jansson, Enskede (SE); Hans Ooterhoff, Upplands-Vasby (SE)

Correspondence Address: CONNOLLY BOVE LODGE & HUTZ LLP, SUITE 800, 1990 M STREET NW, WASHINGTON, DC, 20036-3425, US

(73) Assignee: Ohlins Racing AB, Upplands-Vasby (SE)

(21) Appl. No.: 10/530,869

(22) PCT Filed: Oct. 1, 2003
(86) PCT No.: PCT/SE03/01462

§ 371 Date: Nov. 14, 2005

(30) Foreign Application Priority Data
Oct. 11, 2002 (SE) 0203026-0

(51) Int. Cl. B62D 61/00

(52) U.S. Cl. 180/21

(57) ABSTRACT

A vehicle (1) in the form of a motorcycle comprises a support wheel system located between the front and rear wheels (3, 4) of the motorcycle. The front wheel is arranged in a wheel suspension (5), in or with which the front wheel can, depending on steering actions with steering means (7), be turned into different desired turning steering positions. In the longitudinal section plane of the vehicle in the vertical direction, there is a projection (a) at the front wheel on account of the said suspension. The support wheel system is arranged to assign to the support wheels (10, 11) turning steering positions which depend on the turning steering positions of the front wheel and result in the vehicle, when performing turning steering in primarily the lower speed range of the vehicle, taking up with its said longitudinal section plane a vertical position or a position in relation to the said vertical position which is inclined slightly in the same direction (R) as the assigned turning steering direction of the front wheel. In this way, the driving standard can be raised considerably, especially at lower speeds.

The present invention relates to an arrangement for a vehicle in the form of a motorcycle with a support wheel system which is located between the front and rear wheels of the motorcycle. The front wheel is arranged in a wheel suspension, in or with which it can, depending on steering actions with steering means (handlebars, steering wheel, lever etc.), be turned into different desired turning steering positions. The vehicle is also of such a nature that, in its longitudinal section plane in the vertical direction, there is what is known as a projection at the front wheel on account of the said suspension.

The present invention constitutes a development of the invention according to Swedish patent application 0001210-4 with filing date Apr. 04, 2000 and the same applicant and inventor as the present application.

With regard to the state of the art, reference is made to the said patent application and the patent specification U.S. Pat. No. 4,203,500 cited therein.

Like the said Swedish patent application, the present invention/development is based on the fact that a motorcycle feel is to be present in the vehicle especially at high speeds. Unlike the said American patent specification, the present invention is also based on the knowledge that the support wheels are to be in contact with the ground throughout driving.

The said Swedish patent application also proposes that a scrubbing function (lateral displacement movements) is to be present within the lower speed range or crawling speed range.

There have proved to be problems at great front wheel deflections at low speeds, for example speeds of less than 5 km/h. Owing to the projection referred to in the introduction and the relatively high positioning of the centre of gravity, moments (which can be relatively great) arise which tend to incline the vehicle in a direction opposite to the turning direction. This has to be compensated by the rider, for example by inserting a foot. The Swedish patent application mentions that compensation can also be effected by operable active means (for example hydraulics).

It has nevertheless been found that the proposed scrubbing function leads to twitches in the lateral inclination function of the vehicle and that there are difficulties in effecting the said compensation by inserting a foot and/or the said operation of the active means.

A requirement therefore exists in the said driving situations with low speed and great steering deflection (the vehicle may have a turning diameter of 5-6 metres) to raise the driving standard so that turning or changing direction feels natural without risk of the vehicle overturning and without the said countermeasures having to be taken by the rider.

The present invention aims to solve inter alia this problem and the invention can be considered to be characterized mainly in that inter alia the support wheel system is arranged to assign to the support wheels turning steering positions which depend on the turning steering positions of the front wheel and result in the vehicle, when performing turning steering in primarily the lower speed range of the vehicle, taking up with its said longitudinal section plane a vertical position or a position in relation to the said vertical position which is inclined slightly in the same direction as the assigned turning steering direction of the front wheel.

In a preferred embodiment, the cross axis or cross axes of the support wheels is or are arranged so that it or they is or are directed at least essentially towards the centre of turning of the vehicle. The support wheels are preferably arranged on a unit which bears the support wheels and can be mounted on the vehicle chassis via a ball-and-socket joint by means of which at least three degrees of freedom are brought about with regard to the movement function of the support wheels. Steering damping can be arranged for the support wheel function, for example by means of two steering dampers, the geometry of which, in the ball-and-socket joint embodiment, is arranged so that, when crawling, they limit the steering angles of the support wheel axles and, when the vehicle is put into a curve at high speeds, for example speeds above roughly 50 km/h, they provide a drift angle of, for example, 2-3° on the cross axis. Moreover, the system can have inclination and shock dampers, for example of conventional type.

In an alternative embodiment, the unit bearing the support wheels is arranged rotatably around or with an axis extending horizontally in the longitudinal section plane. The unit bears steering joints for the support wheels, and the steering joints compensate for both lateral movement and steering angle, which can take place positively or actively by means of, for example, hydraulics or passively when use can be made of steering dampers and possible locking functions for higher speeds.

In another embodiment, use is made of a central joint which compensates for the lateral movement and the steering angle of the cross axis. In this case as well, use can be made of active or passive steering (compare above).

In a further embodiment, the support wheel system comprises a unit which bears the support wheels and is arranged rotatably in relation to the chassis of the vehicle in or around three main directions. In this connection, a first direction extends in the horizontal direction or in a slightly inclined manner in relation to the horizontal direction in the said longitudinal direction plane of the vehicle. A second direction extends in the vertical direction in the said longitudinal direction plane, and a third direction extends at right angles to the said longitudinal direction plane. Further characteristics may be that a first axis, for example the pivot axis or an inclination axis, around or with which the unit is rotatable in a first direction of rotation, extends in the first direction, a second axis or a steering axis, around or with which the unit is rotatable in a second direction of rotation, extends in the second direction, and a third axis or spring-action axis, around or with which the unit is rotatable in a third direction of rotation, extends in the third direction.

In one embodiment, use is made of inclination and shock dampers which can be regulated by or via an automatic balancing system. Alternatively, dampers can be coupled to hydraulic cylinders (hydraulics) and regulated manually (by the rider), for example via foot pedal(s).

Further developments of the inventive idea emerge from the following subclaims.

By virtue of the steerability of the support wheels achieved in this way, the need for a scrubbing function and operation of active means in certain low-speed phases is eliminated. By virtue of the steerability and the combination of this with inclination in the right direction, lateral forces which otherwise force the vehicle to be inclined in the wrong direction can be eliminated. The vehicle can be steered with great ease even at the said low speeds and with great deflection of the front wheel. A great freedom of choice can be obtained for the position of the side wheel system between the front and rear wheels.

Sometimes a position closer to the front wheel, which has been difficult to achieve in known systems, is desirable. A locking function at high vehicle speeds of the support wheels contributes to the possibility of retaining the motorcycle feel in the higher speed range. By virtue of the active or passive steering of the support wheels, the support wheels are in contact with the ground throughout driving of the vehicle. The feel of a car is obtained at low speeds.

A for the present proposed embodiment of an arrangement which has the features significant of the invention will be described below with simultaneous reference to accompanying drawings in which

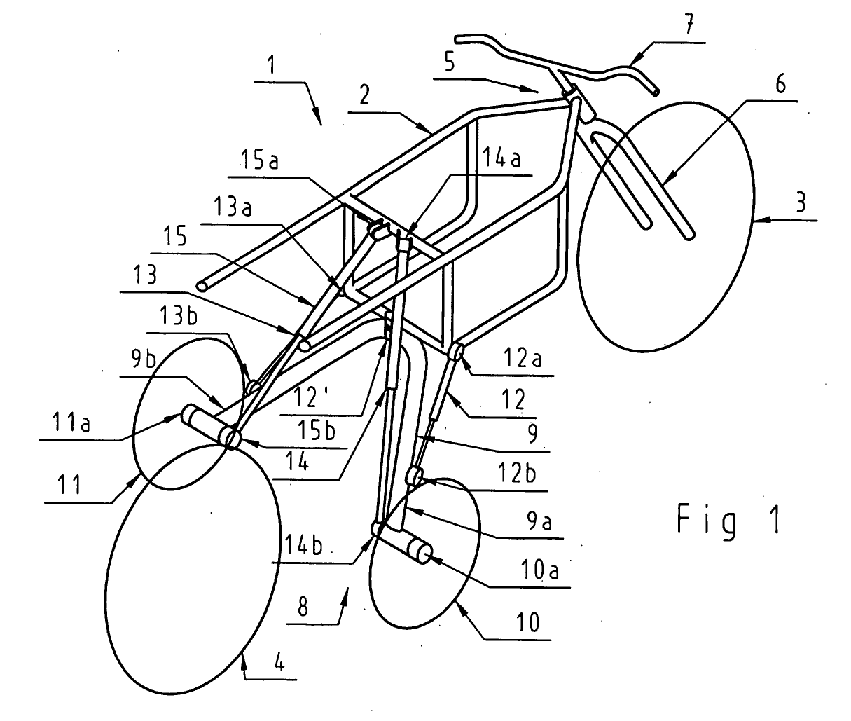

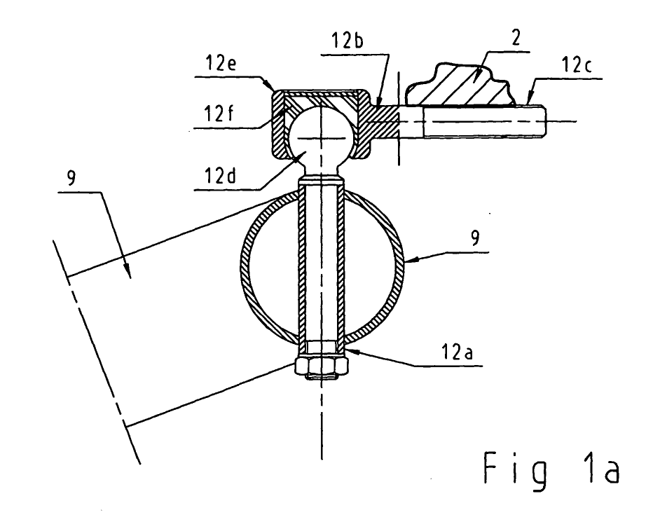

FIG. 1 shows in perspective obliquely from above and from the rear a diagrammatically illustrated vehicle with a first embodiment of a support wheel system;

FIG. 1a shows on enlarged scale in relation to FIG. 1 a ball-and-socket mounting forming part of the system;

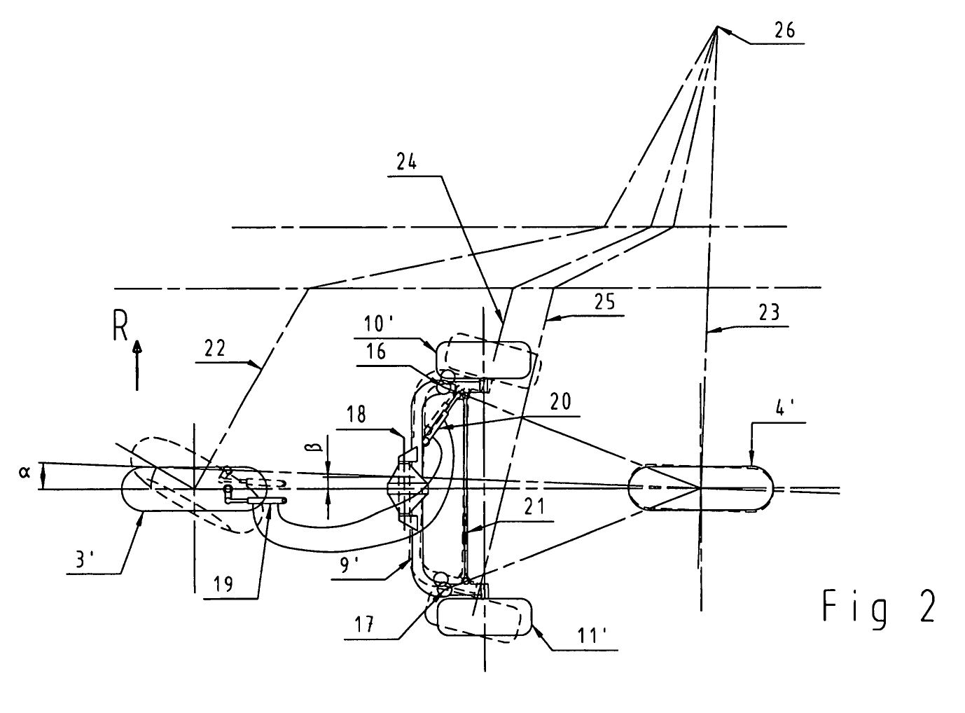

FIG. 2 shows diagrammatically in a horizontal view a second embodiment of the support wheel system;

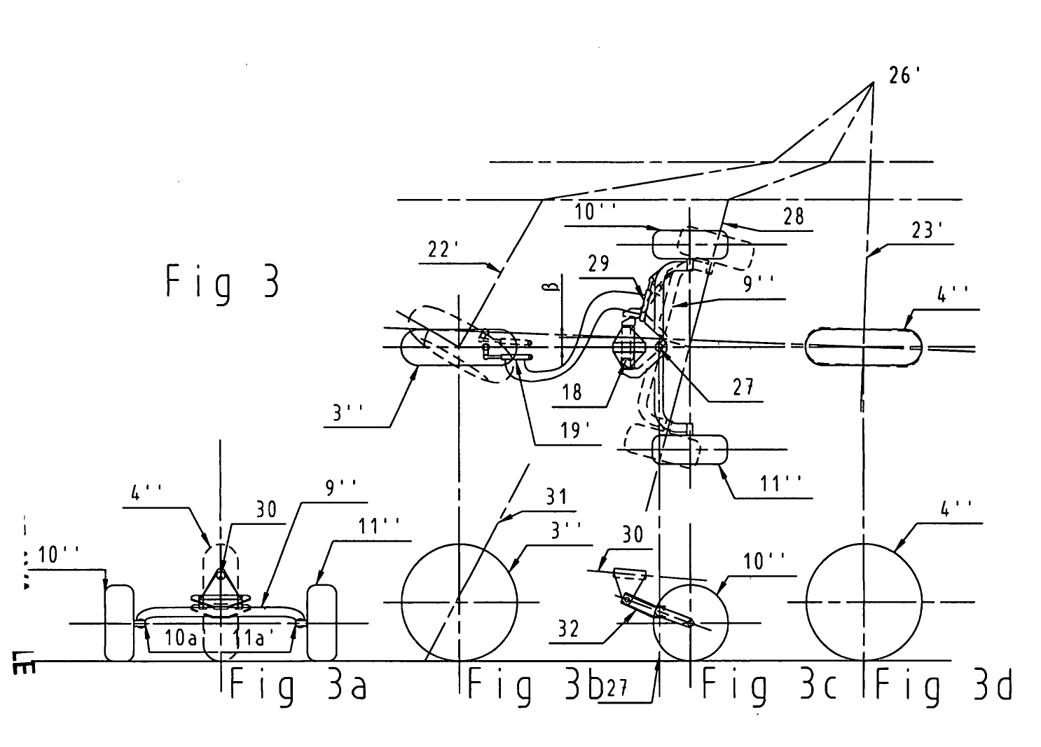

FIGS. 3-3d show various views of parts of a vehicle which uses a third embodiment of the support wheel system;

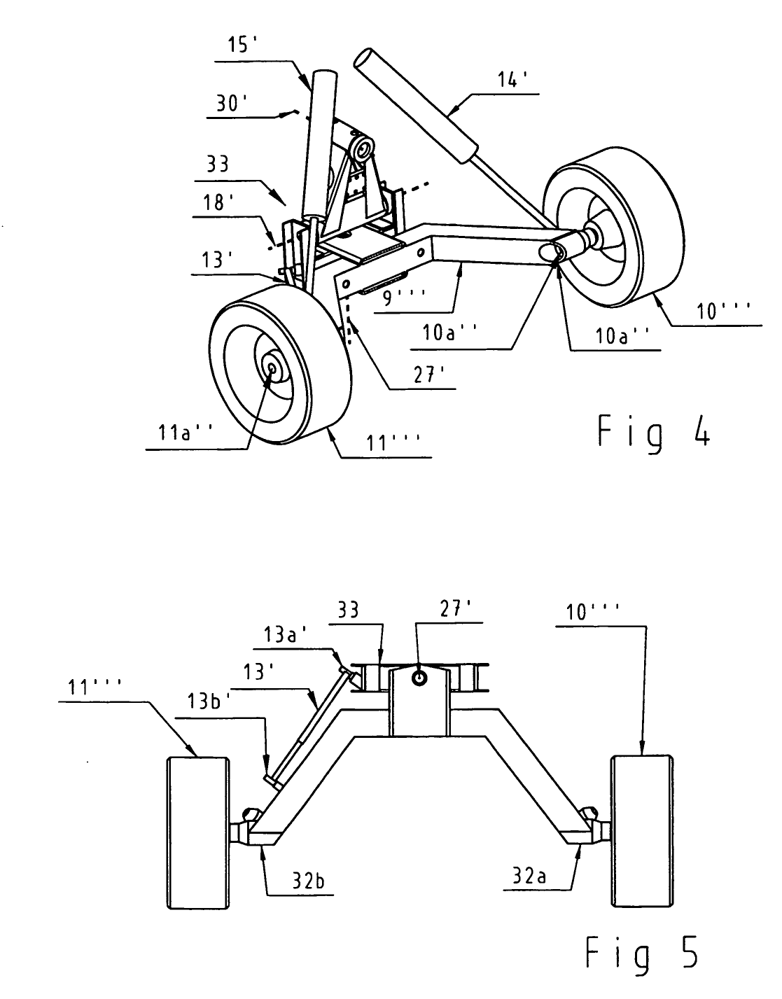

FIG. 4 shows in perspective from above and obliquely from the rear a fourth support wheel system, which has the fundamental construction according to FIGS. 3-3d;

FIG. 5 shows in a horizontal view from above parts of the system according to FIG. 4, and

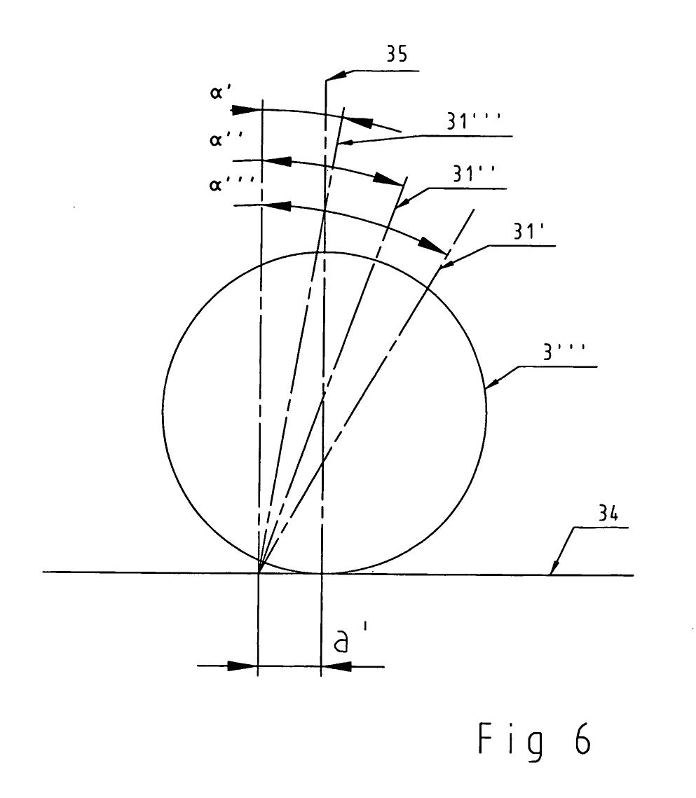

FIG. 6 shows in side view examples of projection in the front wheel geometry at different steering angles.

In FIG. 1, a vehicle is shown generally by 1. Only the parts to which the invention refers are shown. The chassis of the vehicle is indicated by 2, a front wheel by 3, and a rear wheel by 4. The front wheel is arranged with a wheel suspension 5 comprising a fork 6 and handlebars 7. Engine, seat etc. are not shown for the sake of clarity. In the present case, the vehicle consists of a motorcycle which is provided with a support wheel system 8 which, in the illustrative embodiment, comprises a bow-shaped unit 9 which, at its outer or lower ends 9a and 9b, bears support wheels 10 and 11 which can be two or more in number. The unit 9 is mounted on the chassis 2 via a ball-and-socket joint 12′ in its central parts. The unit 9 works with at least three degrees of freedom and is therefore arranged rotatably around or with three mutually perpendicular axes (compare conventional x, y and z axes) making it possible for the support wheels to be turned depending on the turning movements of the front wheel (the vehicle). Alternatively, one axis (the x axis) can be slightly inclined, for example backwards/downwards. The turning movements of the support wheels take place counter to the action of steering dampers 12 and 13 which, when the support wheels turn, strive to return the support wheels to the starting position where turning is zero. The steering dampers are fixed to the chassis and the unit via their ends 12a, 12b and 13a, 13b. The support wheels are mounted on or provided with wheel axles 10a, 11a. Moreover, the vehicle 1 is provided with inclination and shock dampers 14 and 15 which are fixed to the chassis and the respective support wheel at their ends 14a, 14b and 15a, 15b. The said dampers 12, 13 and 14, 15 can be of a kind known per se, for example those sold on the open market by Öhlins Racing AB under the designation SD121 (for 12, 13), or the shock absorber principle applied in vehicle suspension in the basic type 46PRCL (for 14, 15).

FIG. 1a shows an illustrative embodiment of the construction of the ball-and-socket joint. The ball-and-socket joint can consist of a ball-and-socket joint known per se which is used within the vehicle sector.

The ball-and-socket joint has a first part 12a′, by means of which it can be anchored to the unit 9 (compare FIG. 1), for example by means of a nut. The ball-and-socket joint also has a second part 12b′, by means of which it can be anchored to the chassis 2 (compare FIG. 1) which is indicated only symbolically in FIG. 1a. In this connection, the part 12b′ can have an external thread 12c′ which can interact with a corresponding internal thread in the chassis. The part 12a′ is provided with a spherical part 12d′ at one of its ends. The spherical part 12d′ is mounted in a plastic body 12e′ which is arranged at the end of the second part 12b′ and comprises on the inside material/mass made of rubber/plastic 12f′. The ball-and-socket joint is arranged to allow rotations around three axes in a manner known per se. Compare also above.

In the embodiment according to FIG. 2, the ball-and-socket joint has been replaced by two steering axes (one for each support wheel) 16, 17, a spring-action axis 18 and an inclination axis (pivot axis) not shown specifically in FIG. 2. The side wheels can be turned by means of linkages (not shown specifically but see the description for FIG. 3 below). Solid lines for the front and rear wheels 3′, 4′ and the side wheels 10′ and 11′ indicate the positions when the vehicle stands vertically with its longitudinal section plane at right angles to the figure plane of FIG. 2. Broken lines indicate the positions of the said wheels and steering axes when the front wheel has been turned. In this connection, it is characteristic of the system that the vehicle is assigned a small inclination in the same direction as the direction of turning R.

Alternatively, the inclination can be zero relative to the longitudinal direction plane. In this case, the turning of the support wheels is active and is determined by means of hydraulics 19 comprising a hydraulic cylinder. In an alternative embodiment, the adjustability is arranged passively in a known manner. By means of the hydraulics, a hydraulic cylinder 20 acting on the direction of turning of the support wheel 10′ is operated. The support wheel 10′ in turn acts on the support wheel 11′ via a track rod 21 so that the deflection of the two support wheels 10′ and 11′ is essentially the same and dependent on the steering deflection of the front wheel, compare the angle α at the front wheel and the range β at the unit 9′. When turning takes place, the cross axes 22, 23, 24 and 25 of the front and rear wheels and the support wheels extend essentially through the centre of turning 26 of the vehicle.

In the illustrative embodiment according to FIG. 3, the individual steering axes of the support wheels according to FIG. 2 have in principle been replaced by a common steering axis 27 for the unit 9″ which is therefore arranged rotatably in the figure plane of FIG. 3. The support wheels are not arranged steerably on the unit 9″ as in the case according to FIG. 2. In this case as well, a spring-action axis 18′ is present. The support wheels 10″ and 11″ have a common cross axis 28 which extends through the centre of turning of the vehicle as do the cross axes 22′ and 23′ of the front and rear wheels 3″ and 4″. Solid lines indicate the positions of the various components with the vehicle in vertical or upright position and the turning steering deflection zero. Where the term longitudinal direction plane is referred to in this application, this means the case when the vehicle takes up the said vertical position in a plane at right angles to the figure plane of FIG. 3. Broken lines indicate the case when the front wheel has been turned. In this case as well, the vehicle is slightly inclined in the direction of turning of the vehicle. In this case as well, it is conceivable to arrange the system in such a way that the vehicle takes up a non-inclined position when the said turning takes place. The unit 9″ is positively controlled by hydraulics 19′ and a hydraulic cylinder 29 (compare the case of FIG. 2). The unit 9″ can alternatively be passively adjustable in a manner known per se.

According to FIG. 3a, the system includes an inclined axis 30 or pivot axis around or with which the unit can be acted on so that, like the other embodiments described here, the support wheels 10″ and 11″ are in contact with the ground throughout driving of the vehicle. The unit 9″ bears the support wheels 10″, 11″ on bearing axles 10a′, 11a′.

FIG. 3b shows that the longitudinal axis 31 of the mounting of the front wheel 3″ in the chassis is inclined, so that there is a projection a.

FIG. 3c shows the inclination of the axis 30 in the longitudinal direction plane. The support wheels are mounted on their respective bearing axles 10a″ and 11a″ (FIG. 3a) via linkages 32.

FIG. 3d shows the position of the rear wheel 4″ in the longitudinal direction plane of the vehicle.

In accordance with FIG. 4, a backwardly/downwardly inclined first axis/pivot axis 30′ extends in a first direction in the longitudinal direction plane of the vehicle. A steering axis/second axis 27′ extends vertically in a second direction in the vertical plane of the vehicle. A third axis/spring-action axis 18′ extends in a third direction at right angles to the said longitudinal direction plane and the said second axis 27′. In this case, the unit 9′″ is bow-shaped in its horizontal plane and is mounted with or on the steering axis 27′ in a part 33 forming part of or associated with the chassis of the vehicle. The bearing axles of the support wheels 10′″ and 11′″ are indicated by 10a″ and 11a″. In this case as well, use is made of a steering damper 13′ and inclination and shock dampers 14′ and 15′.

In FIG. 5, the linkage at the support wheels 10′″ and 11′″ is indicated by 32a and, respectively, 32b. The figure also shows the arrangement of the steering damper 13′ and its mounting on the chassis/the part 33 via ends 13a′ and 13b′. The steering pin 27′ is mounted in the part 33.

FIG. 6 shows the position of the front wheel in the longitudinal direction plane or vertical plane. The front wheel suspension can have different inclination directions 31′, 31″ and 31′″, the inclination angles being indicated by α′, α″ and α′″. The ground plane is indicated by 34, and a vertical axis through the centre of the wheel by 35. The projection is shown by α′. FIG. 6 is intended to show different steering angles α′, α″ and α′″ with the same projection.

By virtue of the positive or passive deflection or turning of the support wheels depending on the steering of the front wheel, the characteristic and decisive function of inward inclination or inclination in the same direction as the steering direction R of the vehicle or the front wheel is obtained. Within their working range, the steering dampers work with a damping function. In a fully extended or inserted position, an end stop function is performed, which defines a maximum deflection position for the support wheels.

The vehicle can be equipped with an automatic balancing system or manually operable hydraulic cylinders which is or are arranged to regulate the inclination dampers and/or the shock dampers, for example via or with a foot pedal. Regulation can be effected in a manner known per se and reference is made in this connection to FIG. 14 in the Swedish patent application referred to in the introduction.

It is important that the common steering axis 27 (FIG. 3) is able to be displaced a distance/range/gap β (see also FIG. 2) in the steering direction of the front wheel. Corresponding displacement takes place also in the other embodiment of FIGS. 1 and 2 (see 12′, 18 and 30). Said displacements effect the compensations for the lateral movements and the steering angle deflections of the support wheels when the turning steering movements of the vehicle take place. The compensation prevents that the vehicle will be inclined in the wrong or outward direction in relation to the steering direction of the vehicle. Such outward inclination is abnormal at two wheels vehicles. The subject matter also allows driving conditions, in which the support wheels are in contact with the ground even at high speeds, which increases the safety in curves at said high speeds.

The invention is not limited to the illustrative embodiments above but can undergo modifications according to the following patent claims and the inventive idea.

1. Arrangement for a vehicle in the form of a motorcycle with a support wheel system (8) located between the front and rear wheels (3, 4) of the motorcycle, and where the front wheel is arranged in a wheel suspension (5), in or with which the front wheel can, depending on steering actions with steering means (handlebars, steering wheel, lever, etc.) (7), be turned into different desired turning steering positions, and also where, in the longitudinal section plane of the vehicle in the vertical direction, there is a projection (a) at the front wheel on account of the said suspension, characterized in that the support wheel system is arranged to assign to the support wheels (10, 11) turning steering positions which depend on the turning steering positions of the front wheel and result in the vehicle, when performing turning steering in primarily the lower speed range of the vehicle, taking up with its said longitudinal section plane a vertical position or a position in relation to the said vertical position which is inclined slightly in the same direction (R) as the assigned turning steering direction of the front wheel, in that an imaginary axis or imaginary axes extending through the centres of the support wheels, here called cross axis (28) or cross axes (24, 25), extend essentially through the centre of turning (26, 26′) of the vehicle when turning of the vehicle takes place, and in that compensation for the lateral movements and the steering angle deflections of the support wheels at the turning steering movements of the vehicle are effected in accordance with one of the following options;
a) in that the unit bearing the support wheels is mounted on the chassis via a ball-and-socket joint (12′) arranged to effect the compensation;
b) in that the steering joints (16, 17) for the support wheels are arranged to effect the compensation by means of an active or passive arrangement, or
c) in that, by means of its mounting with or around the vertical axis, a unit (9″) bearing of the support wheels (10″ 11″) effects the compensation either actively or passively by possible locking at higher speeds.

2. Arrangement according to Patent claim 1, characterized in that it comprises a unit (9) which bears the support wheels and is mounted on the chassis (2) of the vehicle.

3. Arrangement according to Patent claim 1, characterized in that the ball-and-socket joint (12) is arranged to allow movements of the unit around an imaginary axis extending in the longitudinal section plane and movements around another two imaginary axes which extend at 90° in relation to the imaginary axis extending in the longitudinal section plane.

4. Arrangement according to Patent claim 1, characterized in that the unit bearing the support wheels is arranged rotatably around or with an axis extending essentially horizontally in the longitudinal section plane and bears steering joints for the support wheels, around or with which steering joints (16, 17) the support wheels (10′, 11′) are arranged rotatably relative to the unit (9′) bearing the support wheels in order to adjust themselves in their turning directions when turning of the vehicle takes place.

5. Arrangement according to Patent claim 1, characterized in that the passive system includes or utilizes a locking function arranged so as to be activatable at higher speeds.

6. Arrangement according to Patent claim 1, characterized in that the active system includes a steering function with a hydraulic cylinder (20) for one support wheel (10′) and a steering function by means of a track rod (21) from the said support wheel (10′) to the other support wheel (11′).

7. Arrangement according to Patent claim 1, characterized in that the unit bearing the support wheels is arranged rotatably around or with an axis extending essentially vertically in the longitudinal section plane.

8. Arrangement according to Patent claim 1, characterized in that the support wheels (10″, 11″) are mounted on the unit (9″) bearing the support wheels with or on bearing axis coinciding with a common cross axis (28) of the support wheels.

9. Arrangement according to Patent claim 1, characterized in that the support wheel system comprises a unit which bears the support wheels and is arranged rotatably in relation to the chassis of the vehicle in or around three main directions (18′, 27′, 30′), a first direction extending in the horizontal direction or in a slightly inclined manner in relation to the horizontal direction in the said longitudinal direction plane of the vehicle, a second direction extending in the vertical direction in the said longitudinal direction plane, and a third direction extending at right angles to the said longitudinal direction plane.

10. Arrangement according to Patent claim 9, characterized in that a first axis (30′), here designated an inclination axis, around or with which the unit is rotatable in a first direction of rotation, extends in the first direction, in that a second axis (27′), here designated a steering axis, around or with which the unit is rotatable in a second direction of rotation, extends in the second direction rotation, extends in the second direction, and in that a third axis (18′), here designated a spring-action axis, around or with which the unit is rotatable in a third direction of rotation, extends in the third direction.

11. Arrangement according to Patent claim 1, characterized in that one or more steering damper(s) (12, 13) damping the deflection movement(s) is or are arranged between the chassis and the unit bearing the support wheels or assigned to elements associated with the support wheels, for example the bearing axles of the support wheels.

12. Arrangement according to Patent claim 1, characterized in that the vehicle comprises inclination and shock dampers (14, 15) arranged between the chassis (2) and the unit bearing the support wheels.

13. Arrangement according to Patent claim 12, characterized in that an automatic balancing system or manually operable, for example via a foot pedal, hydraulic cylinders is or are arranged to regulate the inclination and shock dampers.

14. Arrangement according to Patent claim 1, characterized in that the steering dampers (12, 13) are arranged with an end stop function, in which the steering damping function changes into a stop function for the turning movements of the support wheels.
